(19) United States
(12) Patent Application Publication
(10) Pub. No.: US 2009/0300223 A1
(43) Pub. Date: Dec. 3, 2009

(54) METHOD FOR COMMUNICATION BETWEEN AN ELECTRONIC DEVICE AND A TARGET INPUT/OUTPUT DEVICE IN A SECURE DIGITAL INPUT/OUTPUT CARD THROUGH A SECURE DIGITAL INTERFACE, AND SYSTEM FOR IMPLEMENTING THE SAME

(75) Inventors: Hung-Chih Chiang, Kaohsiung City (TW); Ming-Feng Wu, Tainan City (TW); Shih-Ching Hsiao, Kaohsiung City (TW); Chi-Cheng Cheng, Kaohsiung County (TW); Yau-Wen Liu, Kaohsiung City (TW)

Correspondence Address: BAKER & DANIELS LLP;111 E. WAYNE STREET, SUITE 800, FORT WAYNE, IN, 46802, US

(73) Assignee: ETREND ELECTRONICS, INC., Kaohsiung City (TW)

(21) Appl. No.: 12/472,769

(22) Filed: May 27, 2009

(30) Foreign Application Priority Data
May 29, 2008 (TW) 097119881

(51) Int. Cl. G06F 3/00

(52) U.S. Cl. 710/5

(57) ABSTRACT

A method for communication between an electronic device and a target input/output (I/O) device in a secure digital input/output (SDIO) card through a secure digital (SD) interface is provided. The SDIO card includes a SDIO controller. The method includes the steps of: configuring the electronic device to write an I/O command packet at a designated address accessible to both the electronic device and the SDIO controller, the I/O command packet including a command for controlling the operation of the target I/O device; and configuring the SDIO controller to control the operation of the target I/O device according to the I/O command packet written at the designated address.

### CROSS-REFERENCE TO RELATED APPLICATION

This application claims priority of Taiwanese Application No. 097119881, filed on May 29, 2008.

### BACKGROUND OF THE INVENTION

1. Field of the Invention

The invention relates to a communication method, more particularly to a method for communication between an electronic device and a target input/output (I/O) device in a secure digital input/output (SDIO) card through a secure digital (SD) interface, and a system for implementing the same.

2. Description of the Related Art

Secure digital input/output (SDIO) card is developed from secure digital (SD) card, and is increasingly used by portable electronic devices. Examples of SDIO cards include Wi-Fi cards, global positioning system (GSP) cards, Bluetooth cards, etc. It is expected that SDIO will serve as one of the most important interfacing techniques in embedded systems in the future.

Generally speaking, if a driver corresponding to the SDIO card (i.e., the SDIO driver) is provided by an operating system platform, then higher-level application programs in the operating system platform can call the SDIO driver directly for driving an I/O device in the SDIO card. On the other hand, if no SDIO driver is provided by the operating system platform, a SDIO driver must be developed by the SDIO card provider.

For the same I/O device, different SDIO drivers have to be developed for different operating system platforms. For the same operating system platform, different SDIO drivers have to be developed for different I/O devices. Moreover, communication between an operating system platform and the I/O device is impossible if the operating system platform does not support the SDIO driver or SDIO commands.

Therefore, there exists the need for improving compatibility of I/O devices in SDIO cards with different operating system platforms, and for minimizing the time spent on developing drivers.

### SUMMARY OF THE INVENTION

Therefore, the object of the present invention is to provide a method for communication between an electronic device and a target I/O device in a SDIO card through a SD interface that does not require the use of a custom-designed driver, and a system for implementing the same.

According to one aspect of the present invention, there is provided a method for communication between an electronic device and a target I/O device in a SDIO card through a SD interface. The SDIO card includes a SDIO controller. The method includes the steps of: configuring the electronic device to write an I/O command packet at a designated address accessible to both the electronic device and the SDIO controller, the I/O command packet including a command for controlling the operation of the target I/O device; and configuring the SDIO controller to control the operation of the target I/O device according to the I/O command packet written at the designated address.

According to another aspect of the present invention, there is provided a system for communication between an electronic device and a target I/O device. The system includes a SDIO controller adapted to be coupled to the electronic device and the target I/O device, and an application program module adapted to be installed in the electronic device. The application program module configures the electronic device to write an I/O command packet at a designated address accessible to both the electronic device and the SDIO controller. The I/O command packet includes a command for controlling the operation of the target I/O device. The SDIO controller includes a packet decoding unit that is configured to control the operation of the target I/O device according to the I/O command packet written at the designated address.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram of the preferred embodiment of a system for communication between an electronic device and a target input/output (I/O) device according to the present invention;

FIG. 2 is a flow chart illustrating a method for communication between the electronic device and the target I/O device in a SDIO card through a SD interface according to the preferred embodiment;

FIG. 3 is a schematic diagram, illustrating format of an I/O command packet according to the preferred embodiment; and

FIG. 4 is a schematic diagram, illustrating format of an I/O response packet according to the preferred embodiment.

### DETAILED DESCRIPTION OF THE PREFERRED EMBODIMENT

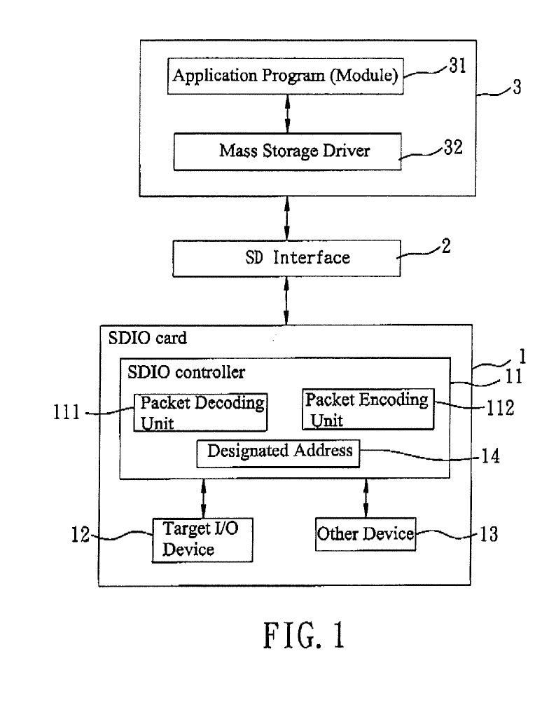

Referring to FIG. 1, the preferred embodiment of a system for communication between an electronic device 3 and a target input/output (I/O) device 12 in a secure digital input/output (SDIO) card 1 via a secure digital (SD) interface 2 includes a secure digital input/output (SDIO) controller 11 and an application program module 31. The SDIO controller 11 is adapted to be coupled to the electronic device 3 and the target I/O device 12. The SDIO controller 11 may be further coupled to other devices 13, such as a flash memory or another I/O device. The application program module 31 is adapted to be installed in the electronic device 3, and configures the electronic device 3 to write an I/O command packet at a designated address 14 accessible to both the electronic device 3 and the SDIO controller 11. The I/O command packet includes a command for controlling the operation of the target I/O device 12. In this embodiment, the designated address 14 is one of a file address and a memory address accessible to both the electronic device 3 and the SDIO controller 11.

It should be noted herein that, although the designated address 14 is shown to be an independent component in the SDIO card 1 in the embodiment illustrated in FIG. 1, the designated address 14 may also be located internal of the SDIO controller 11, such as an internal buffer of the SDIO controller 11, or anywhere else as long as it is accessible to both the electronic device 3 and the SDIO controller 11 in other embodiments of the present invention. It should be further noted herein that the designated address 14 is specifically designated for communication with the target I/O device 12.

In this embodiment, the SDIO controller 11 includes a packet decoding unit 111 that is configured to control the operation of the target I/O device 12 according to the I/O command packet written at the designated address 14. In particular, the packet decoding unit 111 is configured to translate the I/O command packet written at the designated address 14 into a corresponding I/O command, and to control the operation of the target I/O device 12 according to the I/O command.

Moreover, the SDIO controller 11 further includes a packet encoding unit 112 configured to encode an I/O response packet. The I/O response packet includes a response of the target I/O device 12 to control by the packet decoding unit 111. In particular, the packet encoding unit 112 is configured to encode the response of the target I/O device 12 into the I/O response packet for subsequent storage at the designated address 14.

In this embodiment, the application program module 31 further configures the electronic device 3 to read the I/O response packet from the designated address 14 for determining the response of the target I/O device 12 to the I/O command packet.

The application program module 31 configures the electronic device 3 to use a mass storage driver 2 when writing the I/O command packet at the designated address 14 and when reading the I/O response packet from the designated address 14.

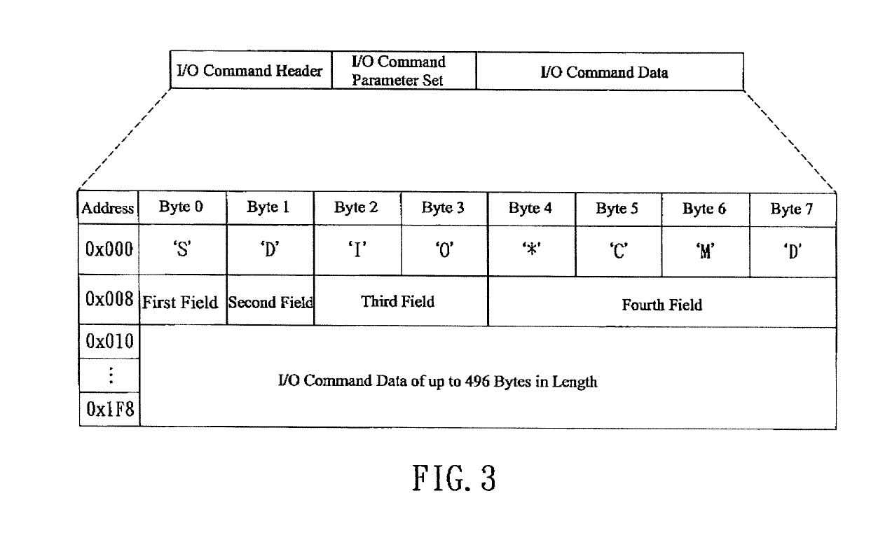

With reference to FIG. 3, the I/O command packet includes an I/O command header for specifying that the I/O command packet is one directed to the target I/O device 12, an I/O command parameter set for specifying information related to the target I/O device 12, and data for the target I/O device 12. The I/O command parameter set includes a field for specifying the target I/O device 12, a field for specifying a command for activating the target I/O device 12, a field for specifying a length of the data for the target I/O device 12, and a reserved field.

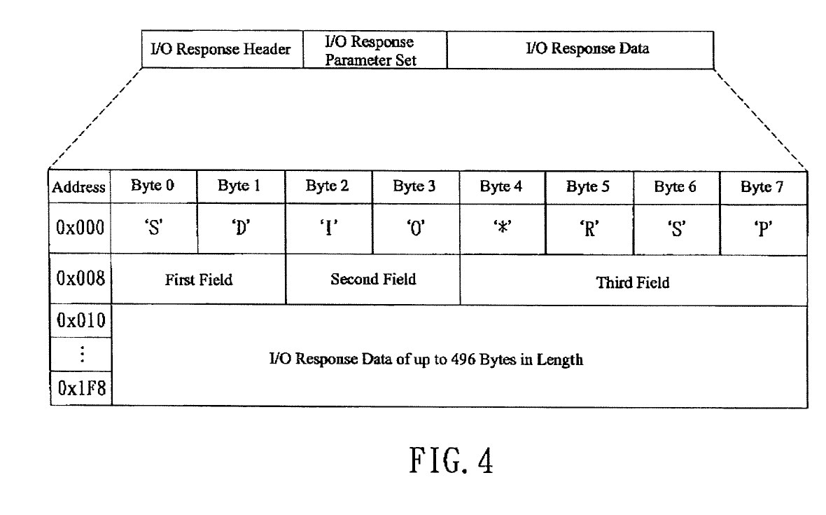

With reference to FIG. 4, the I/O response packet includes an I/O response header for specifying that the I/O response packet is one that originated from the target I/O device 12, an I/O response parameter set for specifying information related to the response of the target I/O device 12 to control by the packet decoding unit 111, and data associated with the response of the target I/O device 12. The I/O response parameter set includes a field for specifying an operation status of the target I/O device 12, a field for specifying a length of the data associated with the response of the target I/O device 12, and a reserved field.

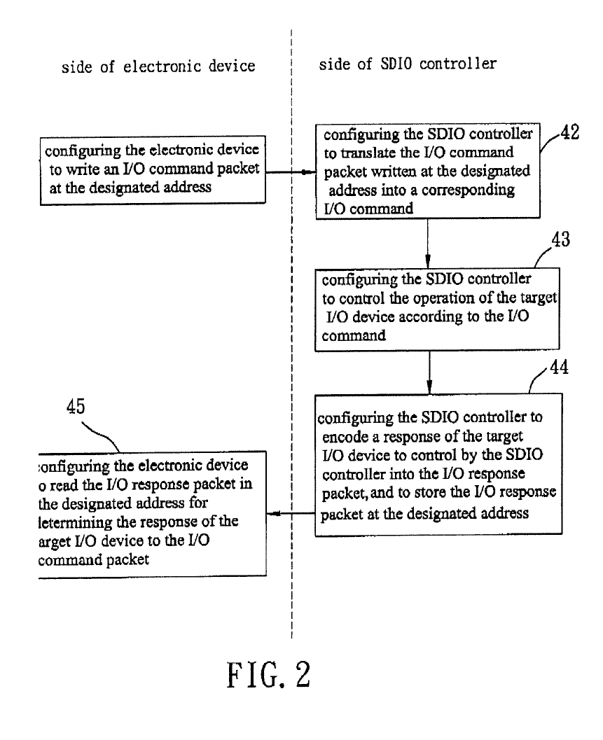

The present invention will be described in more detail with reference to the method for communication between the electronic device 3 and the target I/O device 12 in the SDIO card 1 through the SD interface 2 according to the present invention. With reference to FIG. 2, the method includes the following steps.

In step 41, the electronic device 3 is configured to write an I/O command packet that includes a command for controlling the operation of the target I/O device 12 at the designated address 14 accessible to both the electronic device 3 and the SDIO controller 11.

In this embodiment, the electronic device 3 is provided with an application program 31 (also referred to as the application program module 31 hereinabove) that configures the electronic device 3 to use a mass storage driver 32 when writing the I/O command packet at the designated address 14. The mass storage driver 32 is, for example, internally provided within an operating system, such as Microsoft Windows®, which is installed in the electronic device 3. Moreover, a SD interface 2 is used as an interconnection between the electronic device 3 and the SDIO card 1.

With reference to FIG. 3, in this embodiment, the I/O command header of the I/O command packet is 8 bytes in length, and specifies that the I/O command packet is directed to the target I/O device 12 by using an ASCII code defined as “SDI0*CMD”. The I/O command parameter set of the I/O command packet is 8 bytes in length, is used for specifying information related to the target I/O device 12, and includes four fields. A first field is one byte in length, and specifies the target I/O device 12. A second field is also one byte in length, and specifies a command for activating the target I/O device 12. A third field is two bytes in length, and specifies a length of the data for the target I/O device 12. A fourth field is a four-byte reserved field. Moreover, the data for the target I/O device 12 has a maximum length of 496 bytes.

For example, when it is desired to turn on a serial peripheral interface (SPI) I/O device, and when it is desired to transmit 5-byte data to the SPI I/O device, the first field of the I/O command parameter set specifies that the target I/O device 12 is the SPI I/O device, the second field specifies a command for activating the SPI I/O device, and the third field specifies that the data for the target I/O device 12 is 5 bytes in length.

In step 42, the SDIO controller 11 is configured to translate the I/O command packet written at the designated address 14 into a corresponding I/O command.

In step 43, the SDIO controller 11 is configured to control the operation of the target I/O device 12 according to the I/O command.

in step 44, the SDIO controller 11 is configured to encode a response of the target I/O device 12 to control by the SDIO controller 11 into the I/O response packet and to store the I/O response packet at the designated address 14.

With reference to FIG. 4, in this embodiment, the I/O response header of the I/O response packet is 8 bytes in length, and specifies that the I/O response packet originated from the target I/O device 12 by using an ASCII code defined as “SDIO*RSP”. The I/O response parameter set of the I/O response packet is 8 bytes in length, is used for specifying information related to the response of the target I/O device 12 to control by the SDIO controller 11, and includes three fields. A first field is two bytes in length, and specifies an operation status of the target I/O device 12. A second field is also two bytes in length, and specifies a length of the data associated with the response of the target I/O device 12. A third field is a four-byte reserved field. Moreover, the data associated with the response of the target I/O device 12 has a maximum length of 496 bytes. For example, the first field may be used to indicate whether operation of the target I/O device 12 is successful or not.

In step 45, the electronic device 3 is configured to use the mass storage driver 32 when reading the I/O response packet from the designated address 14 for determining the response of the target I/O device 12 to the I/O command packet.

It should be noted herein that the size and format of each of the I/O command packet and the I/O response packet are system dependent, i.e., they are defined by the SDIO controller 11 and the application program module 31 of the system. Furthermore, it is not necessary for the designated address at which the I/O command packet is written to be the same as the designated address from which the I/O response packet is read.

In sum, the method for communication between an electronic device 3 and a target I/O device 12 of the present invention utilizes the mass storage driver 32 that is already present in the electronic device 3 for writing an I/O command packet at a designated address 14 that is accessible to both the electronic device 3 and the SDIO controller 11 in order for the electronic device 3 to control the operation of a target I/O device 12 in the SDIO card 1, and for reading an I/O response packet from the designated address 14 in order for the electronic device 3 to determine the response of the target I/O device 12 to the I/O command packet. Therefore, for the provider of the SDIO card 1 that is incorporated with the SDIO controller 11 of the present invention, there is no need to develop a driver custom-made for the SDIO card 1 and to be installed in the electronic device 3 when it is required for the electronic device 3 to communicate with the SDIO card 1 for driving the operation of the target I/O device 12 in the SDIO card 1. Consequently, both time and cost are saved during production of the SDIO card 1 if the target I/O device 12 of the SDIO card 1 communicates with the electronic device 3 using the method of the present invention.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for communication between an electronic device and a target input/output (I/0) device in a secure digital input/output (SDIO) card through a secure digital (SD) interface, the SDIO card including a SDIO controller, said method comprising the steps of:
a) configuring the electronic device to write an I/O command packet at a designated address accessible to both the electronic device and the SDIO controller, the I/O command packet including a command for controlling the operation of the target I/O device; and
b) configuring the SDIO controller to control the operation of the target I/O device according to the I/O command packet written at the designated address.

2. The method as claimed in claim 1, wherein step b) includes the sub-steps of:
b-1) configuring the SDIO controller to translate the I/O command packet written at the designated address into a corresponding I/O command; and
b-2) configuring the SDIO controller to control the operation of the target I/O device according to the I/O command,

3. The method as claimed in claim 1, wherein, in step a), the electronic device is provided with an application program that configures the electronic device to use a mass storage driver when writing the I/O command packet at the designated address.

4. The method as claimed in claim 1, further comprising the steps of:
c) configuring the SDIO controller to encode and store an I/O response packet at the designated address, the I/O response packet including a response of the target I/O device to control by the SDIO controller; and
d) configuring the electronic device to read the I/O response packet from the designated address for determining the response of the target I/O device to the I/O command packet.

5. The method as claimed in claim 4, wherein step c) includes the sub-step of configuring the SDIO controller to encode the response of the target I/O device into the I/O response packet for subsequent storage at the designated address.

6. The method as claimed in claim 4, wherein, in step d), the electronic device is provided with an application program that configures the electronic device to use a mass storage driver when reading the I/O response packet from the designated address.

7. The method as claimed in claim 1, wherein the designated address is one of a file address and a memory address accessible to both the electronic device and the SDIO controller.

8. The method as claimed in claim 1, wherein the I/O command packet includes an I/O command header for specifying that the I/O command packet is one directed to the target I/O device, and an I/O command parameter set for specifying information related to the target I/O device.

9. The method as claimed in claim 8, wherein the I/O command packet further includes data for the target I/O device, and the I/O command parameter set includes a field for specifying the target I/O device, a field for specifying a command for activating the target I/O device, a field for specifying a length of the data for the target I/O device, and a reserved field.

10. The method as claimed in claim 4, wherein the I/O response packet includes an I/O response header for specifying that the I/O response packet is one that originated from the target I/O device, and an I/O response parameter set for specifying information related to the response of the target I/O device to control by the SDIO controller.

11. The method as claimed in claim 10, wherein the I/O response packet further includes data associated with the response of the target I/O device, and the I/O response parameter set includes a field for specifying an operation status of the target I/O device, a field for specifying a length of the data associated with the response of the target I/O device, and a reserved field.

12. A system for communication between an electronic device and a target input/output (I/O) device in the secure digital input/output (SDIO) card through a secure digital (SD) interface, said system comprising:
a secure digital input/output (SDIO) controller adapted to be coupled to the electronic device and the target I/O device; and
an application program module adapted to be installed in the electronic device, said application program module configuring the electronic device to write an I/O command packet at a designated address accessible to both the electronic device and said SDIO controller, the I/O command packet including a command for controlling the operation of the target I/O device;
said SDIO controller including a packet decoding unit configured to control the operation of the target I/O device according to the I/O command packet written at the designated address.

13. The system as claimed in claim 12. wherein said packet decoding unit is configured to translate the I/O command packet written at the designated address into a corresponding I/O command, and to control the operation of the target I/O device according to the I/O command.

14. The system as claimed in claim 12, wherein said application program module configures the electronic device to use a mass storage driver when writing the I/O command packet at the designated address.

15. The system as claimed in claim 12, wherein:
said SDIO controller further includes a packet encoding unit configured to encode and store an I/O response packet at the designated address, the I/O response packet including a response of the target I/O device to control by said packet decoding unit; and
said application program module further configures the electronic device to read the I/O response packet from the designated address for determining the response of the target I/O device to the I/O command packet.

16. The system as claimed in claim 15, wherein said packet encoding unit is configured to encode the response of the target I/O device into the I/O response packet for subsequent storage at the designated address.

17. The system as claimed in claim 15, wherein said application program module configures the electronic device to use a mass storage driver when reading the I/O response packet from the designated address.

18. The system as claimed in claim 12, wherein the designated address is one of a file address and a memory address accessible to both the electronic device and said SDIO controller.

19. The system as claimed in claim 12, wherein the I/O command packet includes an I/O command header for specifying that the I/O command packet is one directed to the target I/O device, and an I/O command parameter set for specifying information related to the target I/O device.

20. The system as claimed in claim 19, wherein the I/O command packet further includes data for the target I/O device, and the I/O command parameter set includes a field for specifying the target I/O device, a field for specifying a command for activating the target I/O device, a field for specifying a length of the data for the target I/O device, and a reserved field.

21. The system as claimed in claim 15, wherein the I/O response packet includes an I/O response header for specifying that the I/O response packet is one that originated from the target I/O device, and an I/O response parameter set for specifying information related to the response of the target I/O device to control by said packet decoding unit.

22. The system as claimed in claim 21, wherein the I/O response packet further includes data associated with the response of the target I/O device, and the I/O response parameter set includes a field for specifying an operation status of the target I/O device, a field for specifying a length of the data associated with the response of the target I/O device, and a reserved field.
